(19) United States
(12) Patent Application Publication
(10) Pub. No.: US 2026/0250604 A1
(43) Pub. Date: Aug. 27, 2026

(54) ODOR ELIMINATION MULTI-PURPOSE WIPES

(71) Applicant: Energizer Auto, Inc., St. Louis, MO (US)

(72) Inventor: Sara Rebecca Groetsch, Olmsted Falls, OH (US)

(21) Appl. No.: 19/553,053

(22) Filed: Feb. 27, 2026

Related U.S. Application Data
(60) Provisional application No. 63/764,356, filed on Feb. 27, 2025.

(51) Int. Cl. C11D 3/33; C11D 1/722; C11D 3/20; C11D 3/34; C11D 3/43; C11D 17/04

(52) U.S. Cl. CPC C11D 3/33; C11D 1/722; C11D 3/2068; C11D 3/3481; C11D 3/43; C11D 17/049; C11D 2111/14

(57) ABSTRACT

The present disclosure describes compositions and methods for cleaning and eliminating odor and stains from surfaces. The compositions can include water, one or more chelating agents, one or more glycol ethers, and two or more nonionic surfactants, and optionally one or more preservatives and/or one or more fragrances. The present disclosure also describes a multi-purpose odor-eliminating and cleaning wipe upon which compositions of the present disclosure are disposed. Methods include methods of preparing the compositions and methods of preparing the multi-purpose odor-eliminating and cleaning wipes described herein. The present disclosure also includes methods of cleaning a surface using the compositions and/or wipes described herein.

### CROSS-REFERENCE TO RELATED APPLICATIONS

This application claims the benefit of U.S. Provisional Application No. 63/764,356, filed Feb. 27, 2025, which is incorporated herein by reference in its entirety.

### FIELD OF THE DISCLOSURE

The present disclosure relates to compositions and methods for cleaning and eliminating odor from surfaces. More particularly, the compositions of the present disclosure may provide low foaming, may be disposed on wipes in an easily accessible dispenser, and may provide superior cleaning to the surface.

### BACKGROUND OF THE DISCLOSURE

Effective exterior and interior multi-purpose cleaners for automotives are difficult to develop. Vehicle exterior and interior surfaces include a wide range of materials, such as paint, glass, tires, wheels, and other metal components, fabric, microfiber, carpet, plastic, vinyl, leather, and wood. Vehicle exteriors and interiors also are exposed to different environmental conditions. Exterior surfaces frequently become contaminated with dirt, salt, grease, bugs, tree sap, and bird droppings, for example. This contamination is compounded by the sun and other environmental exposure conditions which can make contaminants more difficult to remove. Interior surfaces may also become contaminated with dirt, salt, and other exterior contaminants, but interiors are also exposed to, for example, food, drink, bodily fluids, cosmetics, and/or chemicals. When not in use, vehicle interiors may not allow ventilation and may experience elevated temperatures when exposed to the sun, which promotes the formation of mold and mildew when water and/or other contaminants are present. Interior contaminants may also become more difficult to remove when exposed to elevated temperatures. Cleaning products that are suitable for use on vehicle exteriors are formulated to be safe and effective on exterior materials and to address exterior contaminants and conditions. These products are often not suitable for use on vehicle interiors and may instead cause additional contamination or damage to vehicle interiors. Similarly, cleaning products suitable for vehicle interiors are formulated to be safe and effective on interior materials and to address interior contaminants. As such, interior products may not be effective for cleaning vehicle exteriors and may cause additional contamination or damage to exterior paint or coatings.

Consumers are burdened with the extent of cleaning tasks, materials, and contaminants presented by automotive interiors and exteriors. Specialty products and formulations for each specific material and contaminant exist, but there is a significant burden to consumers to know which product may be safe and effective to use for each condition. Additionally, it may be cost-prohibitive, time-consuming, and cumbersome for consumers to purchase a different product for each cleaning task. Therefore, there is a need for a safe and effective multi-purpose cleaning product that can address both exterior and interior surfaces, especially those of vehicles. A single multi-purpose cleaning product would allow consumers to save time on cleaning, money on cleaning supplies, and would be easier for consumers to use and store.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes compositions and methods for cleaning and eliminating odor and stains from surfaces. In embodiments, the surface includes exterior or interior surfaces, such as plastic, metal, rubber, leather, glass, wood, fabric, carpet, and painted surfaces. In embodiments, the surface includes a surface within or on a vehicle. For example, the surface can include the surface of a tire, wheel, windshield, window, mirror, lights of a vehicle, and body panel of a vehicle. In embodiments, one or more contaminants are in the stain and the one or more contaminants can include dirt, dust, grime, sunscreen, insect residue, insect repellent, food, tree sap, bird droppings, beverage, cosmetics, and grease.

The present disclosure describes cleaning compositions with components that interact to clean a surface, eliminate odors, and optionally leave a pleasant aroma. In embodiments, the compositions of the present disclosure can include water, one or more chelating agents, one or more glycol ethers, and two or more nonionic surfactants, and optionally one or more preservatives and/or one or more fragrances. For example, the composition can include deionized and/or reverse osmosis R/O water; EDTA; diethylene glycol monobutyl ether or propylene glycol monobutyl ether; C9-C11 ethoxylated fatty alcohol with 4 ethylene oxides (EO), and C9-C11 ethoxylated fatty alcohol with 5.5 EO; BIT; and fragrance with new car aroma.

The present disclosure describes a method of preparing the compositions of the present disclosure, wherein the method includes adding water to a container, while the water is being agitated, adding one or more chelating agents, one or more glycol ethers, and two or more nonionic surfactants, and mixing for 10 minutes (mins) to 20 mins to obtain a homogenous composition. In embodiments, the method can further include adding one or more preservatives and/or one or more fragrances to the container and mixing for an additional 10 mins to 20 mins to obtain a homogenous composition.

Embodiments of the present disclosure include a multi-purpose odor-eliminating and cleaning wipe upon which compositions of the present disclosure are disposed. In embodiments, the wipe includes a substrate, such as rayon, polyester, polypropylene, cellulose, bamboo fibers, wood pulp, cotton, or a combination thereof. For example, the substrate includes viscose rayon and polyester. The present disclosure also includes methods of preparing the multi-purpose odor eliminating and cleaning wipes described herein, the method including applying a composition of the present disclosure onto the substrate of the wipe.

The present disclosure includes methods of cleaning a surface. In embodiments, the methods of cleaning a surface include (i) applying a multi-purpose odor eliminating and cleaning wipe described herein to the surface to remove one or more contaminants on the surface or a stain from the surface and allowing the surface to dry; or (ii) applying a composition described herein to a wipe substrate to obtain a wipe containing the composition, and applying the wipe to the surface to remove one or more contaminants on the surface or a stain from the surface and allowing the surface to dry.

### BRIEF DESCRIPTION OF THE DRAWINGS

FIGS. 1A and 1B show performance testing results of compositions of the present disclosure. Wipes with Composition 1 of Example 1 (FIG. 1A) and wipes with Composition 2 of Example 2 (FIG. 1B) were used to remove (1) tough dirt, (2) dust, (3) grime (butter and clay dirt mixture), (4) smudges, (5) sunscreen, and (6) bug repellant from vinyl, leather, and microsuede surfaces.

FIGS. 2A and 2B show fresh stain competitive testing of Composition 1 of Example 1 (FIG. 2A) and a product currently on the market (Comparative Example 1, FIG. 2B). Wipes containing Composition 1 and Comparative Example 1 were used to remove: stains from (1) ketchup, (2) coffee, (3) makeup, and (4) sunscreen on vinyl; stains from (1) ketchup, (2) mustard, (3) sunscreen and (4) coffee on leather and microsuede surfaces. In FIG. 2B, the circle indicates exemplary coffee stain left behind from wiping with Comparative Example 1 on microsuede.

FIGS. 3A, 3B, and 3C show fresh and aged stain competitive testing of Composition 2 of Example 2 and a product currently on the market (Comparative Example 2). Wipes with Composition 2 and Comparative Example 2 were used to remove fresh stains and aged stains from (1) ketchup, (2) mustard, (3) coffee, and (4) sunscreen on vinyl (FIG. 3A), leather (FIG. 3B), and microsuede (FIG. 3C) surfaces. Aged stains have residual surface damage due to the sunscreen exposure to 85° C. in FIG. 3A.

### DETAILED DESCRIPTION

The present disclosure describes compositions and methods for cleaning and eliminating odor from surfaces. In embodiments, a surface suitable for application of the formulations described herein include such as paint, glass, tires, rubber, wheels, metal, fabric, microfiber, carpet, plastic, vinyl, leather, and wood. The surface can be on the interior and/or exterior of a vehicle. A vehicle can include, for example, a car, truck, bus, train, plane, boat, ship, trailer, recreation vehicle (RV), spacecraft, construction vehicles, farming vehicles, cart, motorcycle, sidecar, and a bicycle. In embodiments, the compositions described herein satisfy consumers' desire for a safe and effective cleaning wipe that removes odors and soils, such as dirt, dust, grime, food and drink residue, cosmetics, and other contaminants from multiple interior and exterior surfaces of vehicles. The present disclosure also describes devices for dispensing the compositions, for example, a container, such as a canister, that dispenses the vehicle cleaning composition on a wipe. In embodiments, the compositions described herein can include fragrance for improved customer satisfaction and use.

The cleaning compositions described herein provide improvement to previous multi-purpose cleaners, improving odor control/elimination, cleaning performance, consumer sensory satisfaction, and ease of use. In embodiments, the cleaning compositions provide odor elimination and optionally also leave a refreshing scent or fragrance, providing improved consumer sensory satisfaction. In embodiments, the cleaning compositions provide improved safety and cleaning performance for vehicle surfaces such as glass, metal, leather, rubber, plastic, vinyl, and carpet with proven superior stain and smudge removing action. The cleaning compositions can effectively remove dirt, dust, grime, food and drink residue, cosmetics, and other contaminants from surfaces. The cleaning compositions and wipe application described herein provide improved customer use and can outperform previous multi-purpose automotive cleaners. In embodiments, the cleaning composition of the present disclosure provides low foaming which improves ease of use for dispensing the composition as a wipe. The multi-purpose cleaner compositions described herein use new chemistries with improved efficacy and consumer sensory responses.

The present disclosure describes cleaning compositions with components that interact to clean a surface, eliminate odors, and optionally leave a pleasant aroma. In embodiments, the cleaning compositions are shelf stable for at least two years under regular (normal) conditions.

The cleaning compositions of the present disclosure can include water, one or more chelating agents, one or more glycol ethers, and two or more nonionic surfactants, and optionally one or more preservatives and/or one or more fragrances.

The water can include clean purified water, such as distilled water, deionized water (DI), or reverse osmosis (R/O) water. In embodiments, compositions of the present disclosure can include by total weight of the composition, about 93.00% to 99.00% water, about 95.00% to 99.00% water, 97.00% to 99.00% water, about 98.055% water, or about 98.096% water.

The one or more chelating agents can include ethylenediaminetetraacetic acid (EDTA), disodium EDTA, tretrasodium EDTA, citric acid, nitilotriacetic acid (NTA), phosphoric acid, sodium calcium edetate, and/or diethylenetriaminepentaacetic acid (DTPA). In embodiments, compositions of the present disclosure can include by total weight of the composition, about 0.01% to 0.50% of one or more chelating agents, about 0.05% to 0.50% of one or more chelating agents, about 0.1% to 0.30% of one or more chelating agents, or about 0.125% of one or more chelating agents. Examples of chelating agents of the present disclosure include VERSENE 100 XL (38%) (Tetrasodium ethylenediamine tetraacetate) and DISSOLVINE E39 (Ethylenediaminetetraacetic acid, tetrasodium salt).

The one or more glycol ethers can include either one or more hydrophilic glycol ethers or one or more hydrophobic glycol ethers. In embodiments, the one or more hydrophilic glycol ethers can include diethylene glycol monomethyl ether, diethylene glycol monoethyl ether, diethylene glycol monopropyl ether, diethylene glycol monoisopropyl ether, diethylene glycol monobutyl ether, propylene glycol monomethyl ether, dipropylene glycol monomethyl ether, tripropylene glycol monomethyl ether, 3-methoxybutanol, 3-methyl-3-methoxybutanol, diethylene glycol dimethyl ether, and diethylene glycol diethyl ether. In embodiments, the one or more hydrophobic glycol ethers can include propylene glycol monobutyl ether, dipropylene glycol monopropyl ether, dipropylene glycol monobutyl ether, diethylene glycol dibutyl ether, and dipropylene glycol dimethyl ether. The one or more glycol ethers can also be both hydrophilic and hydrophobic, for example, dipropylene glycol monopropyl ether. In embodiments, compositions of the present disclosure include by total weight of the composition, about 0.10% to 2.00% of one or more glycol ethers, about 0.20% to 1.50% of one or more glycol ethers, about 0.30% to 1.00% of one or more glycol ethers, or about 0.50% of one or more glycol ethers. In embodiments, glycol ethers of the present disclosure include Butyl CARBITOL (diethylene glycol monobutyl ether) and DOWANOL PnB (propylene glycol monobutyl ether).

The one or more surfactants can include one or more low-foaming or non-foaming surfactants, such as nonionic surfactants. The one or more nonionic surfactants can include ethoxylated alcohol. In embodiments, the one or more nonionic surfactants can include ethoxylated fatty alcohols, and the ethoxylated fatty alcohols can include C9-C11 ethoxylated fatty alcohol. In embodiments, the composition includes two or more nonionic surfactants. The two or more surfactants can include C9-C11 ethoxylated fatty alcohol with 4 ethylene oxides (EO) and 5.5 EO. In embodiments, compositions of the present disclosure can include by total weight of the composition, about 0.20% to 4.00% of two or more surfactants, about 0.50% to 3.00% of two or more surfactants, about 0.80% to 1.50% of two or more surfactants, or about 0.90% of two or more surfactants. For example, compositions of the present disclosure can include by total weight of the composition, about 0.60% of a C9-C11 ethoxylated fatty alcohol with 4 EO and about 0.30% of a C9-C11 ethoxylated fatty alcohol with 5.5 EO totaling about 0.90% of two or more surfactants. Examples of surfactants of the present disclosure include BEROL 260 (C9-11 alcohol ethoxylate) and BEROL 266 (C9-11 Alcohol ethoxylate).

The one or more preservatives can include benzisothiazolinone (BIT), hydantoin germicide, carbamate fungicide, methylisothiazolinone (MIT), and/or methylchloroisothiazolinone (CMIT). In embodiments, preservatives may be an optional ingredient if desired, such as in cases where the compositions are used immediately, and where long-term shelf stability is not necessary. In embodiments, compositions of the present disclosure can include by total weight of the composition, about 0.05% to 0.50% of one or more preservatives, about 0.08% to 0.40% of one or more preservatives, about 0.10% to 0.30% of one or more preservatives, about 0.179% of one or more preservatives, or about 0.22% of one or more preservatives. Examples of preservatives of the present disclosure include ACTICIDE B 20 (BIT) and TROYGUARD BC11 (BIT, MIT, CMIT).

The one or more fragrances can include a fragrance based on commercial market demand, and sensory satisfaction. As an example, for a vehicle, the fragrance can include a new car aroma. In embodiments, the new car aroma can have malodor neutralization mechanisms such as one or more odor neutralizers and/or malodor counteractants which can be used to provide odor reduction or elimination. The one or more odor neutralizers and/or malodor counteractants may include an ester as described in U.S. Pat. No. 7,157,411 B2, combinations of C5 and C6 cyclic aroma chemicals as described in U.S. Pat. No. 6,403,075 B1, olfactory cross-adaptation agents as described in U.S. Publication 2003/0152538 A1, methanoindene compounds as described in WO 2003/070871 A1, or 3-mercapto-3-methyl-hexan-1-ol as described in WO 2006/003053 A1. The one or more odor neutralizers and/or malodor counteractants may utilize masking, partial pressure reduction, and cross-adaption to help reduce malodors. Malodor reducing agents may include menthyl acetate, ambrocenide, ambroxid crystals, boronal, nerolione, citronitrile, irisnitrile, florazon, globanone, globalide, macrolide, ketamber, synambran, sandranol, majantol, mugetanol, farenal, ozonil, rosaphen, or timberol. The one or more malodor reducing agents can be added to the fragrance or be added to the compositions described herein separately from the fragrance. The one or more malodor reducing agents can also be added to the compositions described herein without the fragrance, and the one or more fragrances and the can also be added to the compositions described herein without the malodor reducing agent.

In embodiments, the compositions of the present disclosure can include by total weight of the composition, about 0.05% to 0.50% of one or more fragrances, about 0.08% to 0.40% of one or more fragrances, about 0.10% to 0.30% of one or more fragrances, or about 0.20% of one or more fragrances. An example of a fragrance of the present disclosure includes New Car Fragrance 610713.

The composition can include deionized and/or RO water; EDTA; diethylene glycol monobutyl ether or propylene glycol monobutyl ether; C9-C11 ethoxylated fatty alcohol with 4 EO and C9-C11 ethoxylated fatty alcohol with 5.5 EO; BIT; and fragrance with new car aroma. For example, the composition described herein can include 98.055% or 98.096% deionized and/or RO water; 0.125% EDTA; 0.50% diethylene glycol monobutyl ether or propylene glycol monobutyl ether; 0.60% C9-C11 ethoxylated fatty alcohol with 4 EO and 0.30% C9-C11 ethoxylated fatty alcohol with 5.5 EO; 0.179% or 0.22% of one or more preservatives including BIT; and 0.20% fragrance with new car aroma.

In embodiments, each of the components of the compositions described herein can be a substance including a main ingredient or a mixture including a main ingredient and other ingredients, such as water and other solvents. In some cases, a substance used herein may include a small amount of impurities. In some cases, a mixture used herein may also include small amounts of impurities, and/or other ingredients in unreportable levels. For example, VERSENE 100 XL (38%), an example of EDTA, is a mixture including about 61.0% w/w water, about 38.0% w/w tetrasodium ethylenediamine tetraacetate, and about 1.0-1.7% w/w sodium hydroxide. DISSOLVINE E39, another example of EDTA, is a mixture including about 30-50% w/w ethylenediaminetetraacetic acid, tetrasodium salt, about 0.5-1.9% w/w sodium hydroxide, and about 0.1-1% w/w nitrilotriacetic acid, trisodium salt. Butyl CARBITOL, an example of a glycol ether, is a substance including about 99% w/w diethylene glycol monobutyl ether. DOWANOL PnB, another example of a glycol ether, is a mixture including about 95% w/w propylene glycol monobutyl ether (1-butoxy-2-propanol) and about 5% w/w 2-Butoxy-1-propanol (e.g., Propylene glycol 2-butyl ether). BEROL 260, an example of a surfactant, is a substance mixture including about 90-100% w/w C9-11 alcohol ethoxylate. BEROL 266, an example of a surfactant, is a substance mixture including about 90-100% w/w C9-11 alcohol ethoxylate. ACTICIDE B 20, an example of a preservative, is a mixture including about 20% w/w 1,2-benzisothiazol-3 (2H)-one and about 1-3% sodium hydroxide. TROYGUARD BC-11, an example of a preservative, can include benzothiazole-3 (2h)-one (BIT) (10.1 wt %) as the main ingredient, and 5-chloro-2-methyl-4-isothiazolin-3-one (CMIT) (0.5 wt %), and 2-methyl-2H-isothiazol-3-one (MIT) (0.16 wt %).

The present disclosure describes a method of preparing the compositions of the present disclosure, wherein the method includes adding water to a container, while the water is being agitated, adding one or more chelating agents, one or more glycol ethers, and two or more nonionic surfactants and mixing for about 10 minutes (mins) to 20 mins or about 15 mins to obtain a homogenous composition.

In embodiments, the method can further include adding one or more preservatives and/or one or more fragrances to the container and mixing for an additional about 10 mins to 20 mins or about 15 mins to obtain a homogenous composition.

The present disclosure also describes a multi-purpose odor-eliminating and cleaning wipe upon which compositions of the present disclosure are disposed. In embodiments, the wipe includes a substrate, such as rayon, polyester, polypropylene, cellulose, bamboo fibers, wood pulp, cotton, or a combination thereof. For example, the substrate includes viscose rayon and polyester. The present disclosure includes methods of preparing the multi-purpose odor eliminating and cleaning wipes described herein, the method including applying a composition of the present disclosure onto the substrate of the wipe. In embodiments, the wipe substrate can be in a container, for example, a canister, and the container is filled with the composition, which will disperse evenly throughout the wipe substrate.

The present disclosure describes methods of cleaning a surface. The methods of cleaning a surface can include (i) applying a multi-purpose odor eliminating and cleaning wipe described herein to the surface to remove one or more contaminants on the surface or a stain from the surface and allowing the surface to dry; or (ii) applying a composition described herein to a wipe substrate to obtain a wipe containing the composition, and applying the wipe to the surface to remove one or more contaminants on the surface or a stain from the surface and allowing the surface to dry. The one or more contaminants can include dirt, dust, grime, sunscreen, insect residue, insect repellent, food, tree sap, bird droppings, beverage, cosmetics, and grease. In embodiments, the food can include condiments such as ketchup and mustard, and the beverage includes coffee. In embodiments, the one or more contaminants can be in the stain. In embodiments, the stain can be a fresh stain, such as a stain wherein the contaminants have been present on the surface for one hour or less at room temperature, or an aged stain, such as a stain wherein the contaminants have been present on the surface for more than one hour and/or exposed to elevated temperatures, such as 85° C. for one hour. The surface includes exterior or interior surfaces, such as plastic, metal, rubber, leather, glass, wood, fabric, carpet, and painted surfaces. In embodiments, the surface includes a surface within or on a vehicle. For example, the surface can include the surface of a tire, wheel, windshield, window, mirror, lights of a vehicle, and body panel of a vehicle. The body panel of a vehicle can include an outer panel and an inner body panel.

The compositions described herein can clean and freshen surfaces providing a refreshing scent with the odor-eliminating technology. They can also remove stains and smudges. In embodiments, the surfaces are those of a vehicle; therefore, the compositions can provide a refreshing car scent.

The terms “composition(s)” and “formulation(s)” are used interchangeably to refer to the compositions described herein.

The term “wt %” or “%” in the context of the weight of the component in the composition is used interchangeably to be relative to the total weight of the composition.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means has, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition for cleaning contaminants, eliminating odor, and stains from an interior or exterior surface, such as plastic, metal, rubber, leather, glass, wood, fabric, carpet, and painted surfaces of a vehicle.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### Exemplary Embodiments

The following are exemplary embodiments:
1. A cleaning composition including:
   water;
   one or more chelating agents;
   one or more glycol ethers; and
   two or more nonionic surfactants; and
   optionally one or more preservatives and/or one or more fragrances.
2. The composition of embodiment 1, wherein the composition includes by total weight of the composition:
   about 93.00% to 99.00% water;
   about 0.05% to 0.50% of one or more chelating agents;
   about 0.10% to 2.00% of one or more glycol ethers; and
   about 0.20% to 4.00% of two or more nonionic surfactants; and
   optionally about 0.05% to 0.50% of one or more preservatives; and
   about 0.05% to 0.50% of one or more fragrances.
3. The composition of embodiment 1 or 2, wherein the water is distilled water, deionized water, or reverse osmosis water.
4. The composition of any one of embodiments 1-3, wherein the one or more chelating agents include one or more of ethylenediaminetetraacetic acid (EDTA), citric acid, nitilotriacetic acid (NTA), phosphoric acid, and diethylenetriaminepentaacetic acid (DTPA).
5. The composition of any one of embodiments 1-4, wherein the one or more chelating agents include one or more of disodium EDTA, sodium calcium edetate, and tetrasodium EDTA.
6. The composition of any one of embodiments 1-5, wherein the one or more glycol ethers include either one or more hydrophilic glycol ethers or one or more hydrophobic glycol ethers; and optionally wherein the one or more glycol ethers include a glycol ether that is both hydrophilic and hydrophobic.
7. The composition of any one of embodiments 1-6, wherein the one or more glycol ethers include one or more of diethylene glycol monobutyl ether,
   diethylene glycol monomethyl ether, diethylene glycol monoethyl ether,
   diethylene glycol monopropyl ether, diethylene glycol monoisopropyl ether,
   propylene glycol monomethyl ether, dipropylene glycol monomethyl ether,
   dipropylene glycol monopropyl ether, tripropylene glycol monomethyl ether, 3-methoxybutanol, 3-methyl-3-methoxybutanol, diethylene glycol dimethyl ether, and diethylene glycol diethyl ether.
8. The composition of any one of embodiments 1-6, wherein the one or more glycol ethers include one or more of propylene glycol monobutyl ether, dipropylene glycol mono-n-butyl ether, diethylene glycol dibutyl ether, and dipropylene glycol dimethyl ether.
9. The composition of any one of embodiments 1-6, wherein the one or more glycol ethers include diethylene glycol monopropyl ether.
10. The composition of any one of embodiments 1-9, wherein the two or more nonionic surfactants include ethoxylated alcohols.
11. The composition of any one of embodiments 1-10, wherein the two or more nonionic surfactants include ethoxylated fatty alcohols, and optionally the ethoxylated fatty alcohols include C9-C11 ethoxylated fatty alcohols.
12. The composition of any one of embodiments 1-11, wherein the two or more nonionic surfactants include C9-C11 ethoxylated fatty alcohol with 4 ethylene oxides (EO) and C9-C11 ethoxylated fatty alcohol with 5.5 EO.
13. The composition of any one of embodiments 1-12, wherein the one or more preservatives include one or more of benzisothiazolinone (BIT), hydantoin germicide, carbamate fungicide, methylisothiazolinone (MIT), and methylchloroisothiazolinone (CMIT).
14. The composition of any one of embodiments 1-13, wherein the one or more preservatives include BIT, or wherein the one or more preservatives include a combination of BIT, CMIT, and MIT.
15. The cleaning composition of any one of embodiments 1-14, wherein the one or more fragrances include fragrance with an ability to neutralize or eliminate odors, and optionally, the fragrance includes a new car aroma.
16. The composition of any one of embodiments 1-15, wherein the composition includes;
   deionized water or reverse osmosis water;
   EDTA;
   diethylene glycol monobutyl ether or propylene glycol monobutyl ether;
   C9-C11 ethoxylated fatty alcohol with 4 EO;
   C9-C11 ethoxylated fatty alcohol with 5.5 EO;
   BIT; and
   fragrance with new car aroma.
17. The composition of any one of embodiments 1-16, wherein the composition includes by total weight of the composition:
   about 93.00% to 99.00% deionized water or reverse osmosis water;
   about 0.05% to 0.50% EDTA;
   about 0.10% to 2.00% diethylene glycol monobutyl ether or propylene glycol monobutyl ether;
   about 0.10% to 2.00% C9-C11 ethoxylated fatty alcohol with 4 EO;
   about 0.10% to 2.00% C9-C11 ethoxylated fatty alcohol with 5.5 EO;
   about 0.05% to 0.50% of one or more preservatives including BIT; and
   about 0.05% to 0.50% fragrance with new car aroma.
18. The composition of any one of embodiments 1-17, wherein the composition includes by total weight of the composition:
   about 98.055% deionized water or reverse osmosis water;
   about 0.125% EDTA;
   about 0.50% diethylene glycol monobutyl ether;
   about 0.60% C9-C11 ethoxylated fatty alcohol with 4 EO;
   about 0.30% C9-C11 ethoxylated fatty alcohol with 5.5 EO;
   about 0.22% of one or more preservatives including BIT; and
   about 0.20% fragrance with new car aroma.
19. The composition of any one of embodiments 1-18, wherein the composition includes by total weight of the composition:
   about 98.096% reverse osmosis water;
   about 0.125% EDTA;
   about 0.50% propylene glycol monobutyl ether;
   about 0.60% C9-C11 ethoxylated fatty alcohol with 4 EO;
   about 0.30% C9-C11 ethoxylated fatty alcohol with 5.5 EO;
   about 0.179% of one or more preservatives including BIT; and
   about 0.20% fragrance with new car aroma.
20. A method of preparing the compositions of any one of embodiments 1-19, wherein the method includes: adding water to a container; while the water is being agitated, adding one or more chelating agents, one or more glycol ethers, and two or more nonionic surfactants; and mixing for 10 minutes (mins) to 20 mins to obtain a homogenous composition.
21. The method of embodiment 20, wherein the method further comprises adding one or more preservatives and/or one or more fragrances, and mixing for an additional 10 mins to 20 mins to obtain a homogenous composition.
22. A wipe including a substrate with the composition of any one of embodiments 1-19 applied on the substrate.
23. The wipe of embodiment 22, wherein the substrate includes viscose rayon, polyester, polypropylene, cellulose, bamboo fibers, wood pulp, cotton, or a combination thereof.
24. The wipe of embodiment 22 or 23, wherein the substrate includes viscose, rayon, and polyester.
25. A method of preparing the wipe of any one of embodiments 22-24, wherein the method comprises applying the composition of any one of embodiments 1-19 to the substrate of the wipe.
26. A method of cleaning a surface, wherein:
   (i) the method includes applying the wipe of any one of embodiments 22-24 to the surface to remove one or more contaminants on the surface or a stain from the surface and optionally, allowing the surface to dry; or
   (ii) the method includes applying the composition of any one of embodiments 1-19 to a wipe substrate to obtain a wipe containing the composition, applying the wipe to the surface to remove one or more contaminants on the surface or a stain from the surface, and optionally, allowing the surface to dry.
27. The method of embodiment 26, wherein the one or more contaminants include dirt, dust, grime, sunscreen, insect residue, insect repellent, food, tree sap, bird droppings, beverage, cosmetics, and grease, and optionally, the food includes condiments including ketchup and mustard, and the beverage includes coffee.
28. The method of embodiment 26 or 27, wherein the one or more contaminants are in the stain.
29. The method of any one of embodiments 26-28, wherein the stain is a fresh or aged stain.
30. The method of any one of embodiments 26-29, wherein the surface includes exterior or interior surfaces.
31. The method of any one of embodiments 26-30, wherein the surface includes plastic, metal, rubber, leather, glass, wood, fabric, carpet, and painted surface.
32. The method of any one of embodiments 26-31, wherein the surface is a vehicular surface.
33. The method of any one of embodiments 26-32, wherein the surface is the surface of a tire, wheel, windshield, window, mirror, lights of a vehicle, and body panel of a vehicle, and optionally the body panel of a vehicle includes an outer panel and an inner body panel.

### EXAMPLES

Representative embodiments of the present disclosure will now be described with reference to the following examples that illustrate the principles and practice of the present disclosure.

### Example 1

Example 1 provides an exemplary multi-purpose odor elimination composition of the present disclosure. The multi-purpose odor elimination composition is given in Table 1.

TABLE 1
Composition 1

| | | Component Quantity |
|---|---|---|
| | | wt % (by total weight |
| Component | Function | of the formulation) |
| DI or R/O Water | Diluent | 98.055 |
| VERSENE 100 | Chelating Agent | 0.125 |
| XL (38%) | | |
| EDTA | | |
| Butyl CARBITOL | Solvent | 0.50 |
| BEROL 260 | Degreaser, emulsifier, | 0.60 |
| | dispersing agent | |
| BEROL 266 | Degreaser, emulsifier, | 0.30 |
| | dispersing agent | |
| Fragrance New Car | Fragrance | 0.20 |
| ACTICIDE B 20 | Preservative | 0.22 |
| Total | | 100.00 |

The composition was prepared by (a) charging the required quantity of water into a clean blending tank, (b) under agitation, adding the VERSENE 100 XL (38%) EDTA, the Butyl CARBITOL, the BEROL 260, and the BEROL 266, (c) stirring at a medium speed to blend for at least 15 minutes, (d) under agitation, adding in the Fragrance and the ACTICIDE B 20 preservative, and (e) mixing for an additional 15 minutes until blend was homogenous. The homogeneous composition was then disposed onto an 80/20 PET/Viscose blend 42″ 52 GSM (SPUNTECH) wipe.

The wipes were precut into specific dimensions, such as 7 inches by 8 inches, and perforated. The perforated wipes (at a count of 25) were loaded into a wipe canister, and the composition was dispensed on the wipes in the canister at a ratio of 2.2 lotion per wipe. As an example, for 25 count wipes, 104 g of Composition 1 was used for 80/20 PET/Viscose wipes.

### Example 2

Example 2 provides an exemplary multi-purpose odor elimination composition of the present disclosure. The multi-purpose odor elimination composition is given in Table 2.

TABLE 2
Composition 2

| Component | Function | Component Quantity |
|---|---|---|
| R/O Water | Diluent | 98.096 |
| DISSOLVINE E39 | Solvent | 0.125 |
| DOWANOL PnB | Chelating Agent | 0.5 |
| BEROL 260 | Degreaser, emulsifier, | 0.6 |
| | dispersing agent | |
| BEROL 266 | Degreaser, emulsifier, | 0.3 |
| | dispersing agent | |
| Fragrance New Car | Fragrance | 0.2 |
| ACTICIDE B 20 | Preservative | 0.179 |
| Total | | 100.00 |

The composition was prepared by (a) charging the required quantity of water into a clean blending tank, (b) under agitation, adding the DISSOLVINE E39, the DOWANOL PnB, the BEROL 260, and the BEROL 266, (c) stirring at medium speed and blend for at least 15 minutes, (d) under agitation, adding in the Fragrance and the ACTICIDE B 20 preservative, and (e) mixing for an additional 15 minutes until blend was homogenous. The homogeneous composition was then disposed onto a 100% Viscose (ECO) 50 GSM (SPUNTECH) wipe.

The wipes were precut into specific dimensions, such as 7 inches by 8 inches, and perforated. The perforated wipes (at a count of 25) were loaded into a wipe canister, and the composition was dispensed on the wipes in the canister at a ratio of 2.2 lotion per wipe. As an example, for 25 count wipes, 99 g of Composition 2 was used for 100% Viscose (ECO) wipes.

### Example 3

Example 3 provides an exemplary multi-purpose odor elimination composition of the present disclosure. The multi-purpose odor elimination composition is given in Table 3.

TABLE 3
Composition 3

| | | Component Quantity |
|---|---|---|
| | | wt % (by total weight |
| Component | Function | of the formulation) |
| DI or R/O Water | Diluent | 98.055 |
| VERSENE 100 | Chelating Agent | 0.125 |
| XL (38%) | | |
| EDTA | | |
| Butyl CARBITOL | Solvent | 0.50 |
| BEROL 260 | Degreaser, emulsifier, | 0.60 |
| | dispersing agent | |
| BEROL 266 | Degreaser, emulsifier, | 0.30 |
| | dispersing agent | |
| Fragrance New Car | Fragrance | 0.20 |
| TROYGUARD BC11 | Preservative | 0.22 |
| Total | | 100.00 |

Composition 3 can be prepared by (a) charging the required quantity of water into a clean blending tank, (b) under agitation, adding the VERSENE 100 XL (38%) EDTA, the Butyl CARBITOL, the BEROL 260, and the BEROL 266, (c) stirring at a medium speed to blend for at least 15 minutes, (d) under agitation, adding in the Fragrance and the TROYGUARD BC11 preservative, and (e) mixing for an additional 15 minutes until blend was homogenous. The homogeneous composition can then be disposed onto a wipe, for example an 80/20 PET/Viscose blend 42″ 52 GSM (SPUNTECH) wipe.

### Example 4

Example 4 provides an exemplary multi-purpose odor elimination composition of the present disclosure. The multi-purpose odor elimination composition is given in Table 4.

TABLE 4
Composition 4

| Component | Function | Component Quantity |
|---|---|---|
| R/O Water | Diluent | 98.096 |
| DISSOLVINE E39 | Solvent | 0.125 |
| DOWANOL PnB | Chelating Agent | 0.5 |
| BEROL 260 | Degreaser, emulsifier, | 0.6 |
| | dispersing agent | |
| BEROL 266 | Degreaser, emulsifier, | 0.3 |
| | dispersing agent | |
| Fragrance New Car | Fragrance | 0.2 |
| TROYGUARD BC11 | Preservative | 0.179 |
| Total | | 100.00 |

Composition 4 can be prepared by (a) charging the required quantity of water into a clean blending tank, (b) under agitation, adding the DISSOLVINE E39, the DOWANOL PnB, the BEROL 260, and the BEROL 266, (c) stirring at medium speed and blend for at least 15 minutes, (d) under agitation, adding in the Fragrance and the TROYGUARD BC11 preservative, and (e) mixing for an additional 15 minutes until blend was homogeneous. The homogeneous composition can then be disposed onto a wipe, for example a 100% Viscose (ECO) 50 GSM (SPUNTECH) wipe.

### Experimental Examples

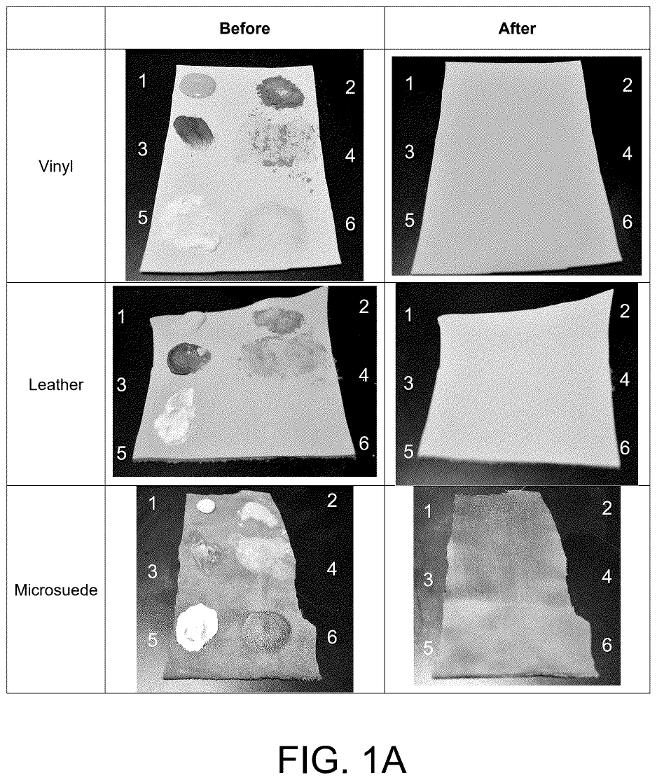

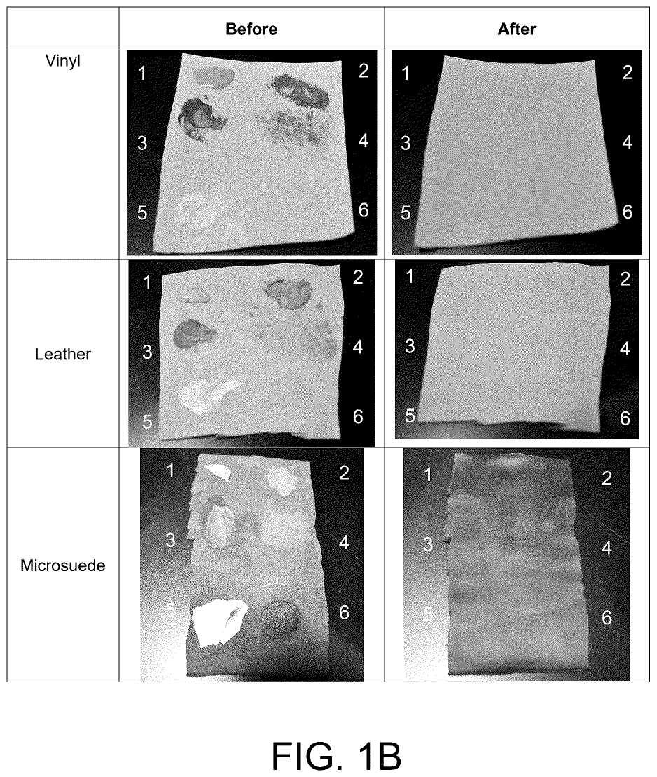

FIGS. 1A & 1B show performance testing results of compositions of the present disclosure. The cleaning wipe with Composition 1 of Example 1 (FIG. 1A) and the cleaning wipe with Composition 2 of Example 2 (FIG. 1B) were used to remove (1) tough dirt, (2) dust, (3) grime (butter and clay dirt mixture), (4) smudges, (5) sunscreen, and (6) bug repellant from vinyl, leather, and microsuede surfaces. Stains were applied on the surface for 1 hour at room temperature before cleaning. The cleaning method for this Experimental Example was to use a cleaning wipe disposed with either the Composition 1 of Example 1 or the Composition 2 of Example 2 to wipe the surface clean of each contaminant. Surfaces were then left until dry. New wipes were used for each surface and replaced as needed for tougher stains.

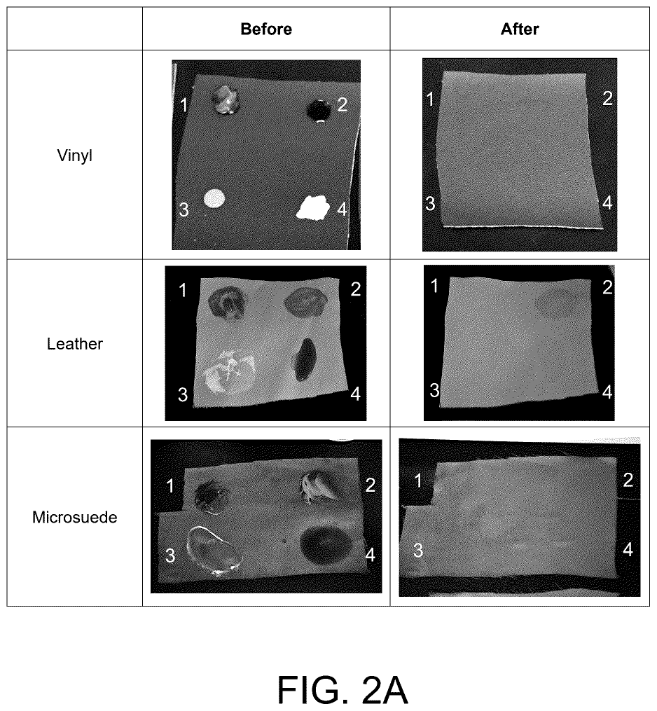

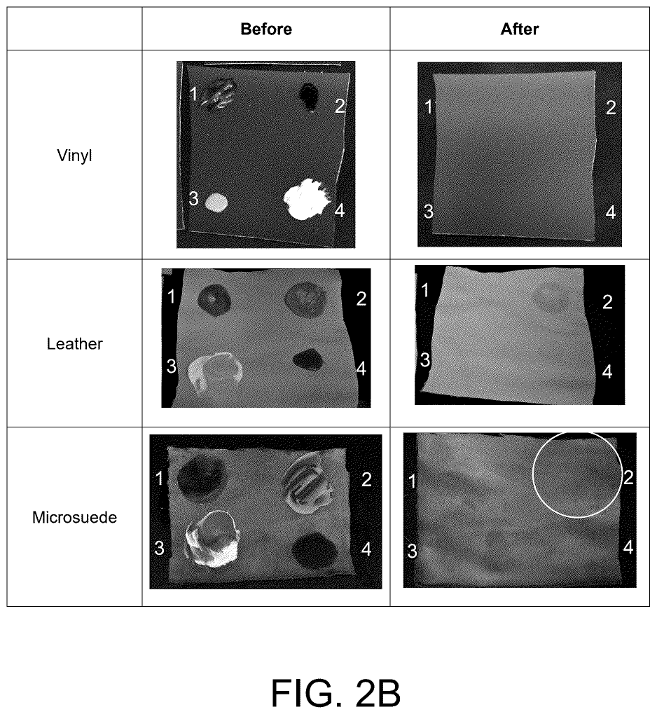

FIGS. 2A & 2B show fresh stain competitive testing of the Composition 1 of Example 1 (FIG. 2A) and a wipe currently on the market (Comparative Example 1) (FIG. 2B). Wipe(s) with Composition 1 and Comparative Example 1 were used to remove stains from (1) ketchup, (2) coffee, (3) makeup, and (4) sunscreen on vinyl surfaces. Wipes with Composition 1 and Comparative Example 1 were used to remove stains from (1) ketchup, (2) mustard, (3) sunscreen, and (4) coffee on leather and microsuede surfaces. Stains were applied on the surface for 1 hour at room temperature before cleaning. The cleaning method for this Experimental Example was to use a cleaning wipe containing either Composition 1 (FIG. 2A) or Comparative Example 1 (FIG. 2B) to wipe the surface clean of each contaminant. Surfaces were then left until dry. New wipes were used for each surface and replaced as needed for tougher stains. As shown in FIG. 2B, the circle shows that a mustard stain was left behind after wiping the mustard (2) off the microsuede with Comparative Example 1. In contrast, FIG. 2A shows that no stain was left behind after wiping the mustard (2) off the microsuede with Composition 1.

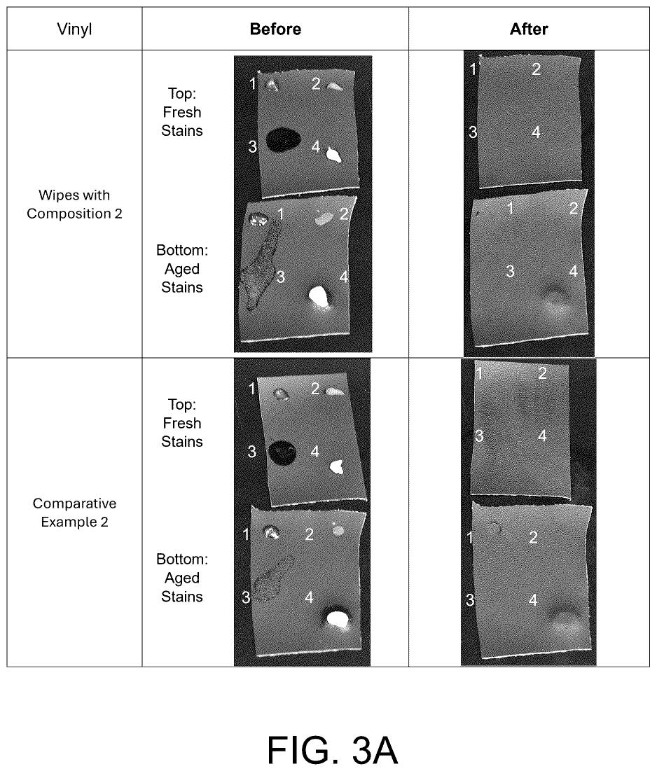

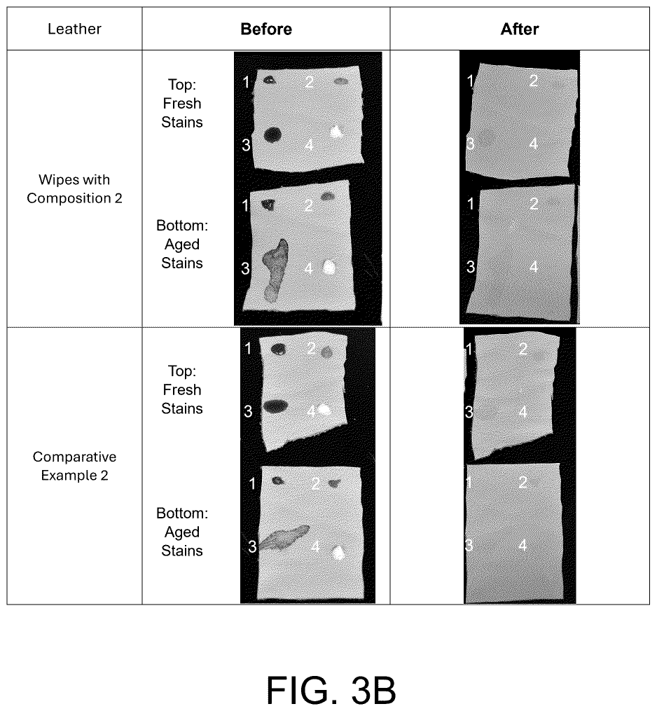

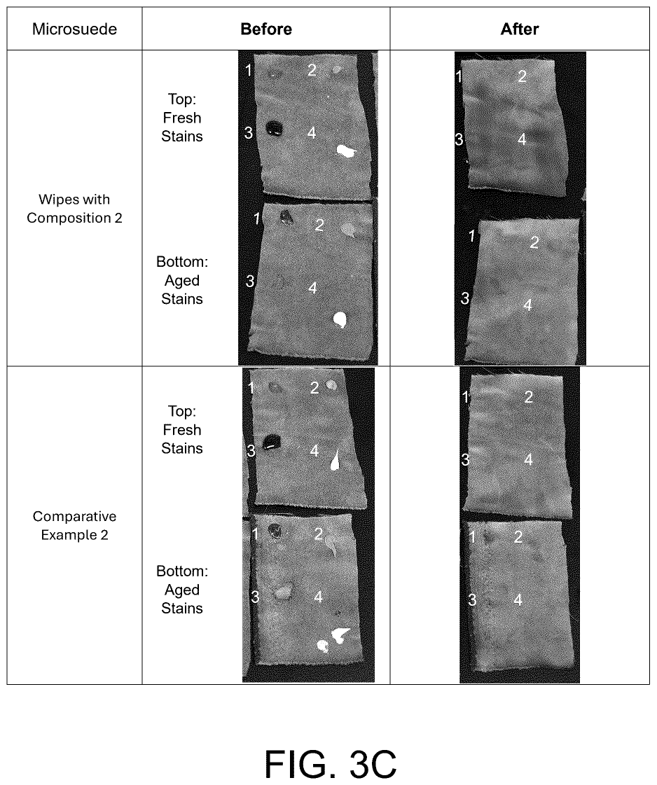

FIGS. 3A-3C show fresh and aged stain competitive testing of Composition 2 of Example 2 and a wipe currently on the market (Comparative Example 2). Wipe(s) with Composition 2 and Comparative Example 2 were used to remove stains from (1) ketchup, (2) mustard, (3) coffee, and (4) sunscreen stains were removed from vinyl (FIG. 3A), leather (FIG. 3B), and microsuede (FIG. 3C) surfaces. Fresh stains (top surfaces) were applied on the surface for 1 hour at room temperature before cleaning. Aged stains (bottom surfaces) were applied on the surface and baked for 1 hour at 85° C. before cleaning. The cleaning method for this Experimental Example was to use a cleaning wipe disposed with Composition 2 or Comparative Example 2 to wipe the surface clean of each contaminant. Surfaces were then left until dry. New wipes were used for each surface and replaced as needed for tougher stains. Aged stains in the vinyl experiment have residual surface damage due to the sunscreen exposure to 85° C. temperature.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It is to be understood that the examples and exemplary embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art.

Furthermore, numerous references have been made to patents, printed publications, journal articles, and other written text throughout this specification (referenced materials herein). The referenced materials are individually incorporated herein by reference in their entirety for their referenced teaching.

1. A cleaning composition comprising:
water;
one or more chelating agents;
one or more glycol ethers; and
two or more nonionic surfactants; and
optionally one or more preservatives and/or one or more fragrances.

2. The composition of claim 1, wherein the composition comprises by total weight of the composition:
about 93.00% to 99.00% water;
about 0.05% to 0.50% of one or more chelating agents;
about 0.10% to 2.00% of one or more glycol ethers; and
about 0.20% to 4.00% of two or more nonionic surfactants; and
optionally about 0.05% to 0.50% of one or more preservatives; and
about 0.05% to 0.50% of one or more fragrances.

3. The composition of claim 1, wherein:
the water is distilled water, deionized water, or reverse osmosis water;
the one or more chelating agents comprise one or more of ethylenediaminetetraacetic acid (EDTA), citric acid, nitilotriacetic acid (NTA), phosphoric acid, diethylenetriaminepentaacetic acid (DTPA), disodium EDTA, sodium calcium edetate, and tetrasodium EDTA;
the one or more glycol ethers comprise either one or more hydrophilic glycol ethers or one or more hydrophobic glycol ethers; and optionally wherein the one or more glycol ethers comprise a glycol ether that is hydrophilic and hydrophobic;
the two or more nonionic surfactants comprise ethoxylated fatty alcohols, and optionally the ethoxylated fatty alcohols comprise C9-C11 ethoxylated fatty alcohols;
the one or more preservatives comprise one or more of benzisothiazolinone (BIT), hydantoin germicide, carbamate fungicide, methylisothiazolinone (MIT), and methylchloroisothiazolinone (CMIT); or
the one or more fragrances comprise fragrance with an ability to neutralize or eliminate odors, and optionally, the fragrance comprises a new car aroma.

4. The composition of claim 1, wherein the two or more nonionic surfactants comprise C9-C11 ethoxylated fatty alcohol with 4 ethylene oxides (EO) and C9-C11 ethoxylated fatty alcohol with 5.5 EO.

5. The composition of claim 1, wherein the one or more glycol ethers comprise one or more of propylene glycol monobutyl ether, dipropylene glycol mono-n-butyl ether, diethylene glycol dibutyl ether, and dipropylene glycol dimethyl ether.

6. The composition of claim 1, wherein the composition comprises:
deionized water or reverse osmosis water;
EDTA;
diethylene glycol monobutyl ether or propylene glycol monobutyl ether;
C9-C11 ethoxylated fatty alcohol with 4 EO;
C9-C11 ethoxylated fatty alcohol with 5.5 EO;
BIT; and
fragrance with new car aroma.

7. A method of preparing a composition of claim 1, wherein the method comprises: adding water to a container; while the water is being agitated, adding one or more chelating agents, one or more glycol ethers, and two or more nonionic surfactants; and mixing for 10 minutes (mins) to 20 mins to obtain a homogenous composition.

8. The method of claim 7, wherein the method further comprises adding one or more preservatives and/or one or more fragrances, and mixing for an additional 10 mins to 20 mins to obtain a homogenous composition.

9. A wipe comprising a substrate with the composition of claim 1 applied on the substrate.

10. The wipe of claim 9, wherein the substrate comprises viscose, rayon, polyester, polypropylene, cellulose, bamboo fibers, wood pulp, cotton, or a combination thereof.

11. The wipe of claim 9, wherein the substrate comprises viscose, rayon, and polyester.

12. A method of preparing the wipe of claim 9, wherein the method comprises applying the composition to the substrate of the wipe.

13. A method of cleaning a surface, wherein the method comprises applying the composition of claim 1 to a wipe substrate to obtain a wipe containing the composition, and applying the wipe to the surface to remove one or more contaminants on the surface or a stain from the surface.

14. The method of claim 13, wherein the one or more contaminants comprise dirt, dust, grime, sunscreen, insect residue, insect repellent, food, tree sap, bird droppings, beverage, cosmetics, and grease, and optionally, the food comprises condiments comprising ketchup and mustard, and the beverage comprises coffee.

15. The method of claim 13, wherein the one or more contaminants are in the stain.

16. The method of claim 13, wherein the stain is a fresh or aged stain.

17. The method of claim 13, wherein the surface comprises exterior or interior surfaces.

18. The method of claim 13, wherein the surface comprises plastic, metal, rubber, leather, glass, wood, fabric, carpet, and painted surface.

19. The method of claim 13, wherein the surface is a vehicular surface.

20. The method of claim 13, wherein the surface is the surface of a tire, wheel, windshield, window, mirror, lights of a vehicle, and body panel of a vehicle, and optionally the body panel of a vehicle comprises an outer panel and an inner body panel.
